(19) United States
(12) Patent Application Publication
(10) Pub. No.: US 2010/0080519 A1
(43) Pub. Date: Apr. 1, 2010

(54) CONNECTOR ALIGNMENT USING ALIGNMENT BUMPS AND NOTCHES

(76) Inventors: JAMYUEN KO, San Jose, CA (US); Hengju Cheng, Mountain View, CA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/242,311

(22) Filed: Sep. 30, 2008

(51) Int. Cl. G02B 6/36

(52) U.S. Cl. 385/93

(57) ABSTRACT

Described herein are connector alignment techniques and components that use alignment bumps and notches to facilitate high-bandwidth scaling. The alignment bumps may be located, for example, on the Converged I/O (CIO) standard-A receptacle and plug housings, on a USB compliant receptacle/plug pair, on a HDMI interface. That is, the alignment techniques and components described here in may be used with virtually any optical interface. The features may be molded into the receptacle housing to become one piece.

### TECHNICAL FIELD

Embodiments of the invention relate to optical fiber connectors. More particularly, embodiments of the invention relate to devices and techniques for aligning optical fibers with connectors.

### BACKGROUND

There currently exist several interfaces that allow one device to connect with another device. A few examples include Universal Serial Bus (USB), Parallel ports, IEEE 1394, etc. These interfaces include electrical interfaces within a receptacle and a counterpart plug. The receptacle and the plug are designed so that the plug may be inserted into the receptacle to provide an electrical connection over which the connected devices may communicate. These receptacles and plugs are manufactured with tolerances that are appropriate for the dimensions of the electrical contacts and other factors.

In high volume production, interface manufacturers may try to use increased tolerances to shorten the lead-time and reduce manufacturing cost. However, excessive increases in tolerances may result in problematic operation of the interface.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1a is a front view of one embodiment of a receptacle having alignment bumps.

FIG. 1b is a side view of one embodiment of a receptacle having alignment bumps.

FIG. 1c is a perspective view of one embodiment of a receptacle having alignment bumps.

FIG. 2 is a perspective view of one embodiment of a counterpart plug for the receptacle illustrated in FIGS. 1a-1c.

FIG. 3a is a front view of one embodiment of a receptacle having alignment notches.

FIG. 3b is a side view of one embodiment of a receptacle having alignment notches.

FIG. 3c is a perspective view of one embodiment of a receptacle having alignment notches.

FIG. 4 is a perspective view of one embodiment of a counterpart plug for the receptacle illustrated in FIGS. 1a-1c.

FIG. 5 illustrates one embodiment of a plug having alignment features.

FIG. 6 is a block diagram of one embodiment of a computer system.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

In one embodiment described herein, there are provided a connector pairs, which may take the form of a USB form factors with optics, to facilitate optical communications. This can be provided with loose manufacturing tolerance with bigger core fiber (i.e., greater than 65 micrometers). However, the drawback of using bigger core fiber is the limitation of high-bandwidth scaling.

Described herein are connector alignment techniques and components that use alignment bumps and notches to facilitate high-bandwidth scaling. The alignment bumps shown in the Figures may be located, for example, on the Converged I/O (CIO) standard-A receptacle and plug housings, on a USB compliant receptacle/plug pair, on a HDMI interface. That is, the alignment techniques and components described herein may be used with virtually any optical interface. In one embodiment, the feature may be molded into the receptacle housing to become one piece. The tapered area of the bumps may be used for lead-in guiding purpose during plug engagement. In alternate embodiments, other connector housings may be similarly configured.

In one embodiment, the alignment notches are located on the plug side with bumps on the receptacle side. In another embodiment, the alignment notches are located on the receptacle side with the bumps on the plug side. The notches are areas that are recessed for the alignment purpose to receive a counterpart bump during connector engagement. This alignment helps by limiting the lateral movement between the plug and receptacle so that smaller core fiber (i.e., less than 65 micrometers) can be used for high-bandwidth scaling.

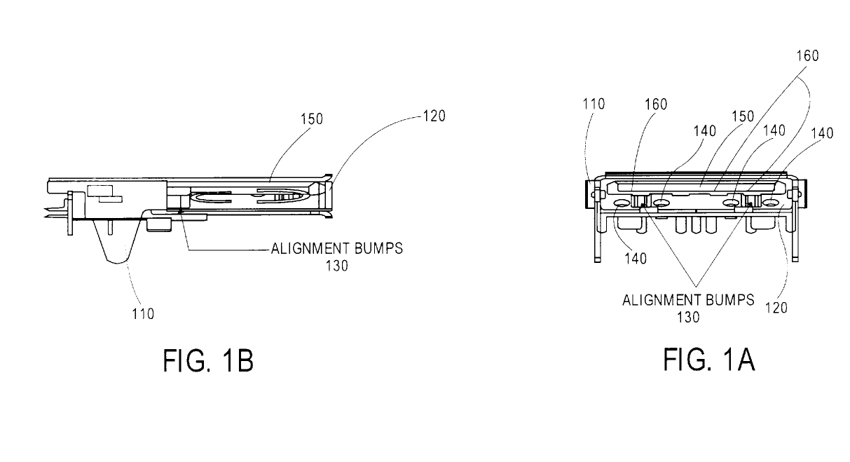

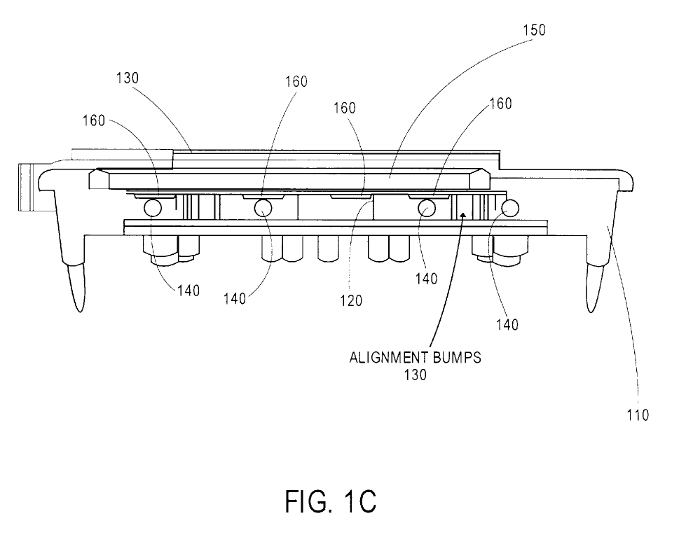

FIG. 1a is a front view of one embodiment of a receptacle having alignment bumps. The example of FIG. 1a is based on a USB-compliant receptacle; however, other standards and interfaces may also include the alignment bumps as described herein.

In one embodiment, the receptacle includes shield 110. Within shield 110 resides receptacle 120 that is configured with alignment bumps 130. In the example of FIG. 1a, two alignment bumps are provided. In alternate embodiments, a different number of bumps may be used, for example, 1 bump, 3 bumps, 4 bumps, 5 bumps, 6 bumps, etc. In the example of FIG. 1a receptacle 120 includes four lenses 140. In alternate embodiments, any number of lenses may be included, for example, 1 lens, 2 lenses, 6 lenses, 8 lenses, 10, lenses, etc. The lenses may function to focus light transmitted via an optical fiber (not illustrated in FIG. 1a).

In the example of FIG. 1a, alignment bumps 130 are positioned between pairs of lenses 140. While this illustrates one embodiment, other embodiments where the bumps are not positioned between the lens pairs may also be provided. Receptacle 120 may further include contacts 160 that may provide power, conform to a USB standard, may be non-functional, or may conform to a non-USB standard. In one embodiment contacts 160 are positioned on contact board 150.

FIG. 1b is a side view of one embodiment of a receptacle having alignment bumps. In the example of FIG. 1b, alignment bumps 130 are located on the back wall of receptacle 120. In alternate embodiments, alignment bumps 130 may be positioned in a different portion of receptacle 120. For example, alignment bumps 130 may run along contact board 150.

FIG. 1c is a perspective view of one embodiment of a receptacle having alignment bumps. In the example of FIG. 1c, alignment bumps 130 are located on the back wall of receptacle 120. In alternate embodiments, alignment bumps 130 may be positioned in a different portion of receptacle 120. For example, alignment bumps 130 may run along contact board 150.

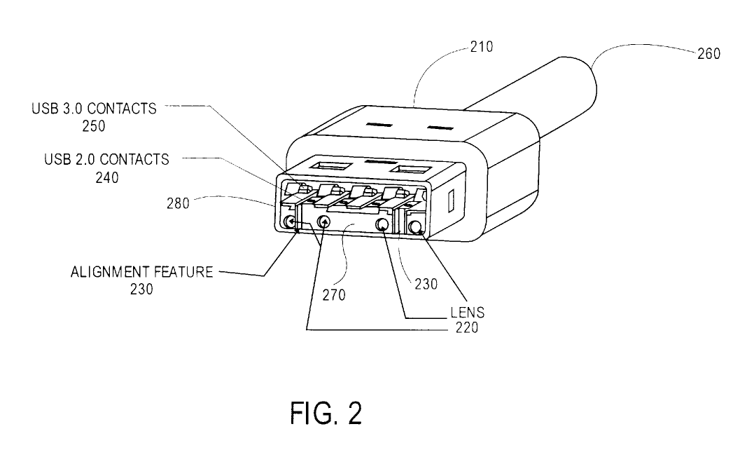

FIG. 2 is a perspective view of one embodiment of a counterpart plug for the receptacle illustrated in FIGS. 1a-1c. The example of FIG. 2 is based on a USB-compliant receptacle; however, other standards and interfaces may also include the alignment features as described herein. In the example of FIG. 2, the alignment features are notches that align with the alignment bumps illustrated in FIGS. 1a-1c. The alignment bumps and notches function to maintain the connected plug and receptacle in a satisfactory optical alignment.

Enclosure 210 may include mechanical and/or electrical connections between electrical conductors and/or optical fibers included in cable 260. In one embodiment, the plug may include board 270 that includes one or more contacts 240 and 250. In one embodiment, USB 2.x-compliant contacts 240 are included as well as USB 3.x-compliant contacts 250. In alternate embodiments, only USB 2.x-compliant contacts 240 or USB 3.x-compliant contacts 250 are included. In other embodiments, contacts for other standards, for example, HDMI, or other optical and/or electrical may be included.

In one embodiment, the plug includes shield 280. Within shield 280 resides board 270 that is configured with alignment features 230. In the example of FIG. 2, two alignment features are provided. In alternate embodiments, a different number of features, for example, 1 notch, 3 notches, 4 notches, 5 notches, 6 notches, etc. In the example of FIG. 2, the plug includes four lenses 220. In alternate embodiments, any number of lenses may be included, for example, 1 lens, 2 lenses, 6 lenses, 8 lenses, 10, lenses, etc. The lenses may function to focus light transmitted via an optical fiber.

In the example of FIG. 2, alignment features 230 are positioned between pairs of lenses 220. While this illustrates one embodiment, other embodiments where the bumps are not positioned between the lens pairs may also be provided. The plug may include contacts 240 and/or 250 that may provide power, conform to a USB standard, may be non-functional, or may conform to a non-USB standard. In one embodiment contacts 240 and/or 250 are positioned on contact board 270.

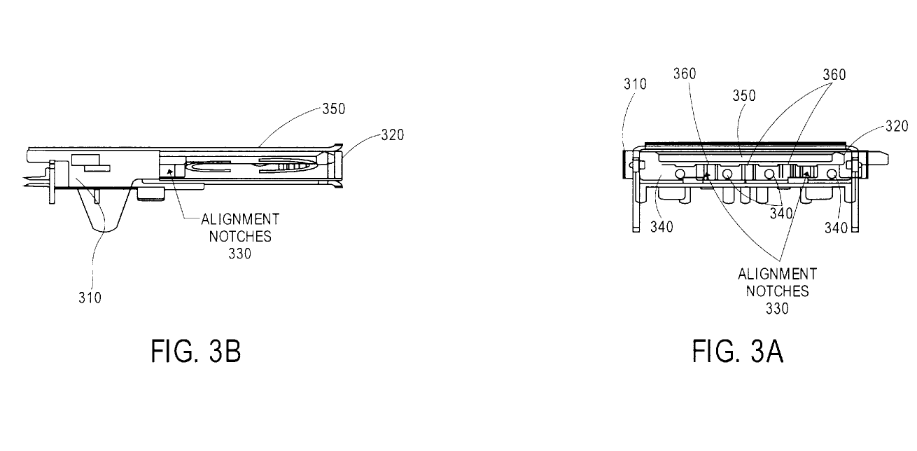

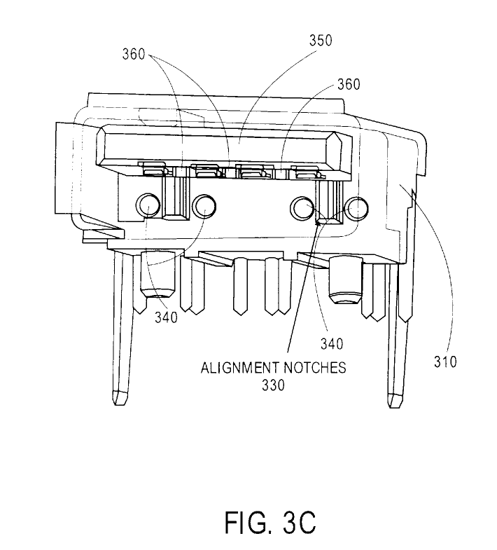

FIG. 3a is a front view of one embodiment of a receptacle having alignment notches. The example of FIG. 3a is based on a USB-compliant receptacle; however, other standards and interfaces may also include the alignment notches as described herein.

In one embodiment, the receptacle includes shield 310. Within shield 310 resides receptacle that is configured with alignment notches 330. In the example of FIG. 3a, two alignment notches are provided. In alternate embodiments, a different number of notches, for example, 1 notch, 3 notches, 4 notches, 5 notches, 6 notches, etc. In the example of FIG. 3a receptacle 320 includes four lenses 340. In alternate embodiments, any number of lenses may be included, for example, 1 lens, 2 lenses, 6 lenses, 8 lenses, 10, lenses, etc. The lenses may function to focus light transmitted via an optical fiber (not illustrated in FIG. 3a).

In the example of FIG. 3a, alignment notches 330 are positioned between pairs of lenses 340. While this illustrates one embodiment, other embodiments where the notches are not positioned between the lens pairs may also be provided. Receptacle 320 may further include contacts 360 that may provide power, conform to a USB standard, may be non-functional, or may conform to a non-USB standard. In one embodiment contacts 360 are positioned on contact board 350.

FIG. 3b is a side view of one embodiment of a receptacle having alignment notches. In the example of FIG. 3b, alignment notches 330 are located on the back wall of receptacle 320. In alternate embodiments, alignment notches 330 may be positioned in a different portion of receptacle 320. For example, alignment notches 330 may run along contact board 350.

FIG. 3c is a perspective view of one embodiment of a receptacle having alignment notches. In the example of FIG. 3c, alignment notches 330 are located on the back wall of receptacle 320. In alternate embodiments, alignment notches 330 may be positioned in a different portion of receptacle 320. For example, alignment notches 330 may run along contact board 350.

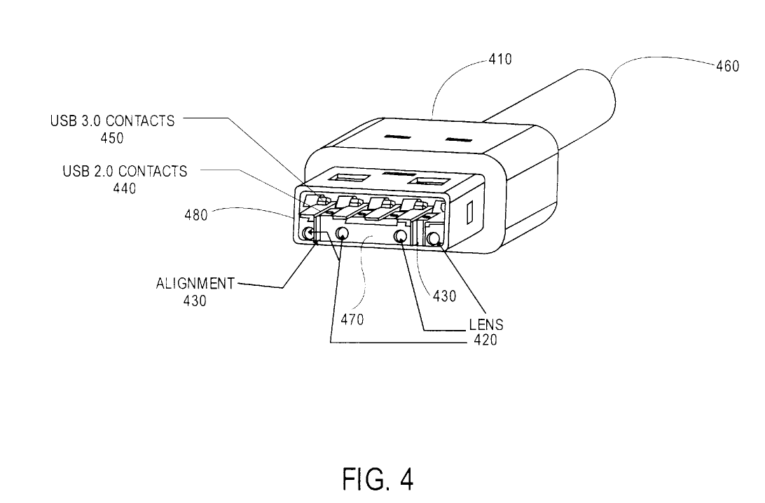

FIG. 4 is a perspective view of one embodiment of a counterpart plug for the receptacle illustrated in FIGS. 3a-3c. The example of FIG. 4 is based on a USB-compliant receptacle; however, other standards and interfaces may also include the alignment features as described herein. In the example of FIG. 4, the alignment features are bumps that align with the alignment notches illustrated in FIGS. 3a-3c. The alignment notches and bumps function to maintain the connected plug and receptacle in a satisfactory optical alignment.

Enclosure 410 may include mechanical and/or electrical connections between electrical conductors and/or optical fibers included in cable 460. In one embodiment, the plug may include board 470 that includes one or more contacts 440 and 450. In one embodiment, USB 2.x-compliant contacts 440 are included as well as USB 3.x-compliant contacts 450. In alternate embodiments, only USB 2.x-compliant contacts 440 or USB 3.x-compliant contacts 450 are included. In other embodiments, contacts for other standards, for example, HDMI, or other optical and/or electrical may be included.

In one embodiment, the plug includes shield 480. Within shield 480 resides board 470 that is configured with alignment features 430. In the example of FIG. 4, two alignment bumps are provided. In alternate embodiments, a different number of bumps, for example, 1 bump, 3 bumps, 4 bumps, 5 bumps, 6 bumps, etc. In the example of FIG. 4, the plug includes four lenses 420. In alternate embodiments, any number of lenses may be included, for example, 1 lens, 2 lenses, 6 lenses, 8 lenses, 10, lenses, etc. The lenses may function to focus light transmitted via an optical fiber.

In the example of FIG. 4, alignment bumps 430 are positioned between pairs of lenses 420. While this illustrates one embodiment, other embodiments where the bumps are not positioned between the lens pairs may also be provided. The plug may include contacts 440 and/or 450 that may provide power, conform to a USB standard, may be non-functional, or may conform to a non-USB standard. In one embodiment contacts 440 and/or 450 are positioned on contact board 470.

The lenses described in FIG. 1a-4 are optically coupled to respective fibers for providing high speed optical data throughput. While four lenses are shown, this is by way of example, more or fewer may be provided. In one embodiment, the lenses may be within tapered holes for fiber self-alignment in installation. The tapered holes may have metal inserts for added rigidity.

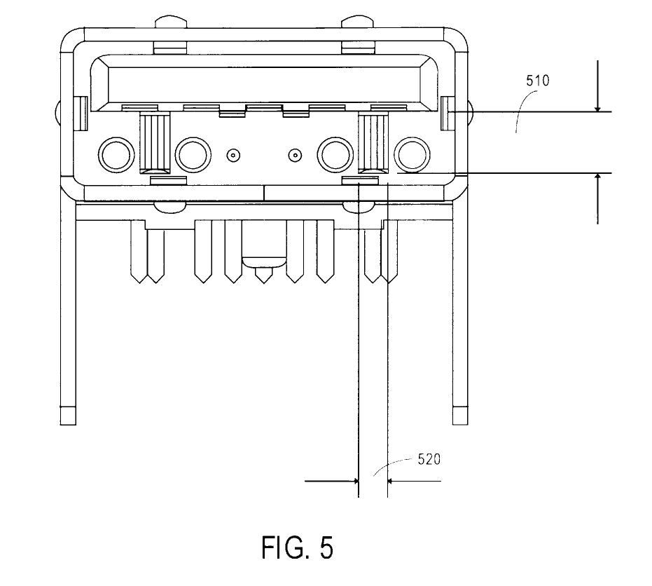

FIG. 5 illustrates one embodiment of a plug having alignment features. The illustration provides example dimensions for alignment features to be used with USB plug embodiments. For plugs with different sizes, different alignment feature dimensions may be utilized.

In one embodiment, the height of an alignment feature 510 may be in the range of 1.5 mm to 2.2 mm. In another embodiment, the height of an alignment feature 510 may be in the range of 1.75 mm to 2.0 mm. In another embodiment, the height of an alignment feature 510 may be in the range of 1.90 mm to 1.99 mm. In another embodiment, the height of an alignment feature 510 may be 1.96 mm.

In one embodiment, the width of an alignment feature 520 may be in the range of 0.7 mm to 1.2 mm. In another embodiment, the height of an alignment feature 520 may be in the range of 0.75 mm to 1.0 mm. In another embodiment, the height of an alignment feature 520 may be in the range of 0.90 mm to 0.95 mm. In another embodiment, the height of an alignment feature 520 may be 0.9 mm.

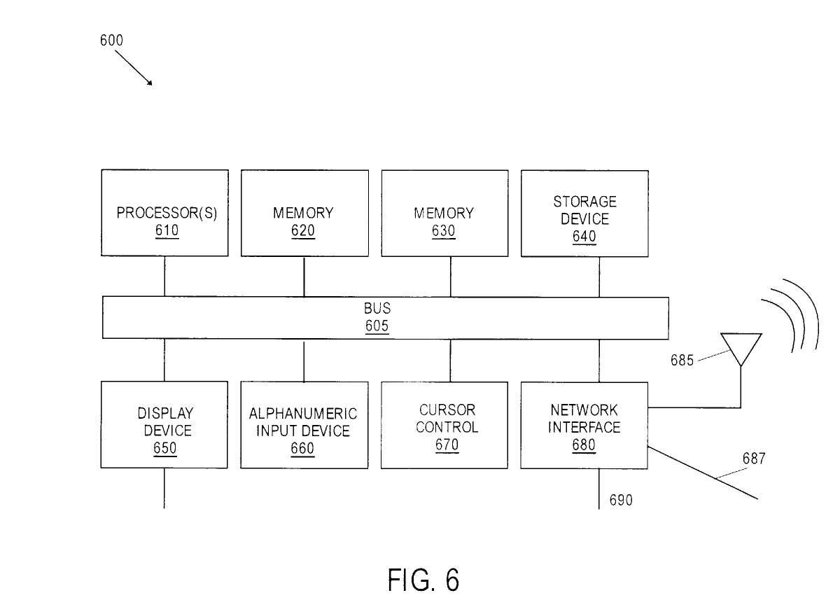

FIG. 6 is a block diagram of one embodiment of a computer system. The computer system illustrated in FIG. 6 is intended to represent a range of computer systems. Alternative computer systems can include more, fewer and/or different components.

Computer system 600 includes bus 605 or other communication device to communicate information, and processor 610 coupled to bus 605 to process information. While computer system 600 is illustrated with a single processor, computer system 600 can include multiple processors and/or co-processors. Computer system 600 further includes random access memory (RAM) or other dynamic storage device 620 (referred to as memory), coupled to bus 605 to store information and instructions to be executed by processor 610. Memory 620 also can be used to store temporary variables or other intermediate information during execution of instructions by processor 610.

Computer system 600 also includes read only memory (ROM) and/or other static storage device 630 coupled to bus 605 to store static information and instructions for processor 610. Storage device 640 is coupled to bus 605 to store information and instructions. Storage device 640 such as a magnetic disk or optical disc and corresponding drive can be coupled to computer system 600.

Computer system 600 can also be coupled via bus 605 to display device 650, such as a cathode ray tube (CRT) or liquid crystal display (LCD), to display information to a user. Alphanumeric input device 660, including alphanumeric and other keys, is typically coupled to bus 605 to communicate information and command selections to processor 610. Another type of user input device is cursor control 670, such as a mouse, a trackball, or cursor direction keys to communicate direction information and command selections to processor 610 and to control cursor movement on display 650. Computer system 600 further includes network interface 680 to provide access to a network, such as a local area network.

Electronic system 600 further may include network interface(s) 680 to provide access to a network, such as a local area network. Network interface(s) 680 may include, for example, a wireless network interface having antenna 685, which may represent one or more antenna(e). Network interface(s) 680 may also include, for example, a wired network interface to communicate with remote devices via network cable 687, which may be, for example, an Ethernet cable, a coaxial cable, a fiber optic cable, a serial cable, or a parallel cable.

In one embodiment, network interface 680 may include optical interface 690 that may be an optical interface as described above. That is, information may be transmitted to and received from computer system 600 over one or more optical fibers coupled with network interface 680 via an interface having alignment bumps and notices described herein to assist in aligning lenses that may be used to transmit optical information. In one embodiment, optical interface 690 may conform to a Universal Serial Bus Standard 2.0 or later. Other optical interface standards can also be supported.

In one embodiment, network interface(s) 680 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 180 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Instructions are provided to memory from a storage device, such as magnetic disk, a read-only memory (ROM) integrated circuit, CD-ROM, DVD, via a remote connection (e.g., over a network via network interface 680) that is either wired or wireless and stored in, for example, memory 620. In alternative embodiments, hard-wired circuitry can be used in place of or in combination with software instructions. Thus, execution of sequences of instructions is not limited to any specific combination of hardware circuitry and software instructions.

A computer-readable medium includes any mechanism that provides content (e.g., computer executable instructions) in a form readable by an electronic device (e.g., a computer, a personal digital assistant, a cellular telephone). For example, a computer-readable medium may include read only memory (ROM); random access memory (RAM); magnetic disk storage media; optical storage media; flash memory devices; etc.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a receptacle housing;
a plurality of lenses disposed within the receptacle housing;
a plurality of alignment bumps on a face of the receptacle housing.

2. The apparatus of claim 1 further comprising a plurality of optical fibers aligned with the plurality of lenses.

3. The apparatus of claim 2 wherein the plurality of optical fibers comprises at least one fiber having a core diameter of less than 65 micrometers.

4. The apparatus of claim 1 wherein the plurality of alignment bumps comprises two alignment bumps.

5. The apparatus of claim 4 wherein each of the two alignment bumps is disposed between a pair of lenses.

6. The apparatus of claim 1 wherein the receptacle conforms to a Universal Serial Bus (USB) Standard 2.0 or greater and includes electrical contacts that conform to the USB Standard 2.0 or greater.

7. The apparatus of claim 1 wherein the receptacle conforms to a Universal Serial Bus (USB) Standard 3.0 or greater and includes electrical contacts that conform to the USB Standard 3.0 or greater.

8. An apparatus comprising:
a receptacle housing;
a plurality of lenses disposed within the receptacle housing;
a plurality of alignment notches on a face of the receptacle housing.

9. The apparatus of claim 8 further comprising a plurality of optical fibers aligned with the plurality of lenses.

10. The apparatus of claim 9 wherein the plurality of optical fibers comprises at least one fiber having a core diameter of less than 65 micrometers.

11. The apparatus of claim 8 wherein the plurality of alignment notches comprises two alignment notches.

12. The apparatus of claim 11 wherein each of the two alignment notches is disposed between a pair of lenses.

13. The apparatus of claim 8 wherein the receptacle conforms to a Universal Serial Bus (USB) Standard 2.0 or greater and includes electrical contacts that conform to the USB Standard 2.0 or greater.

14. The apparatus of claim 8 wherein the receptacle conforms to a Universal Serial Bus (USB) Standard 3.0 or greater and includes electrical contacts that conform to the USB Standard 3.0 or greater.

15. An apparatus comprising:
a plug having at least an engaging member to engage a corresponding receptacle;
a plurality of lenses;
a plurality of alignment bumps on the engaging member.

16. The apparatus of claim 15 further comprising a plurality of optical fibers aligned with the plurality of lenses.

17. The apparatus of claim 16 wherein the plurality of optical fibers comprises at least one fiber having a core diameter of less than 65 micrometers.

18. The apparatus of claim 15 wherein the plurality of alignment bumps comprises two alignment bumps.

19. The apparatus of claim 18 wherein each of the two alignment bumps is disposed between a pair of lenses.

20. The apparatus of claim 15 wherein the receptacle conforms to a Universal Serial Bus (USB) Standard 2.0 or greater and includes electrical contacts that conform to the USB Standard 2.0 or greater.

21. The apparatus of claim 15 wherein the receptacle conforms to a Universal Serial Bus (USB) Standard 3.0 or greater and includes electrical contacts that conform to the USB Standard 3.0 or greater.

22. An apparatus comprising:
a plug having at least an engaging member to engage a corresponding receptacle;
a plurality of lenses;
a plurality of alignment notches on the engaging member.

23. The apparatus of claim 22 further comprising a plurality of optical fibers aligned with the plurality of lenses.

24. The apparatus of claim 23 wherein the plurality of optical fibers comprises at least one fiber having a core diameter of less than 65 micrometers.

25. The apparatus of claim 22 wherein the plurality of alignment notches comprises two alignment notches.

26. The apparatus of claim 25 wherein each of the two alignment notches is disposed between a pair of lenses.

27. The apparatus of claim 22 wherein the receptacle conforms to a Universal Serial Bus (USB) Standard 2.0 or greater and includes electrical contacts that conform to the USB Standard 2.0 or greater.

28. The apparatus of claim 22 wherein the receptacle conforms to a Universal Serial Bus (USB) Standard 3.0 or greater and includes electrical contacts that conform to the USB Standard 3.0 or greater.
